(19) United States
(12) Patent Application Publication
(10) Pub. No.: US 2015/0020179 A1
(43) Pub. Date: Jan. 15, 2015

(54) CLOUD COMPUTING SYSTEM

(71) Applicant: Tadashi Yokoyama, Tokyo (JP)

(72) Inventor: Tadashi Yokoyama, Tokyo (JP)

(73) Assignee: INTERLINK CO. LTD., Tokyo (JP)

(21) Appl. No.: 14/241,559

(22) PCT Filed: Jun. 15, 2012
(86) PCT No.: PCT/JP2012/065376

§ 371 Date: Feb. 27, 2014

(30) Foreign Application Priority Data
Sep. 8, 2011 (JP) 2011-196374

(51) Int. Cl. H04L 29/06; G06F 17/30

(52) U.S. Cl. CPC H04L 63/08; G06F 17/30197
USPC 726/7; 707/827

(57) ABSTRACT

The cloud computing system includes a mounting process unit that performs a process for mounting an external storage managed by an entity that is different from an entity that is providing a cloud computing service effected by said cloud computing system; a user information storage unit for storing in an associated manner user identification information for a user who is using said mounted external storage and network identification information for said external storage; and a cloud control process unit for using information stored in said external storage to execute, for a user terminal used by said user, a control process for said cloud computing system.

### FIELD OF THE INVENTION

The present invention relates to a cloud computing system, and more particularly, to a cloud computing system that enhances the confidentiality of user information

### BACKGROUND OF THE INVENTION

Heretofore, when using a computer, a user (user can include a company, group, or other such organization in addition to an individual) himself has stored and managed software and information in the computer environment being utilized. In so doing, the user himself has had to purchase and install the software, and to apply patches to update to the latest versions of the software. The user has also had to carry out appropriate management procedures for the information used in his work, such as providing the required storage areas and performing backups as needed, and encrypting confidential information. However, it has been burdensome for users to perform these tasks.

In the meantime, as network environments have developed, it has become desirable to be able to use software and information at anytime from anywhere, and in recent years attention has focused on cloud computing.

Cloud computing is a technology in which software and information used by a user are stored on a server provided at a data center or the like, and the user is able to utilize the software and the information by accessing the server. As a result, the user is freed from the tasks of purchasing, installing, and updating the software as mentioned above, and is also spared the task of managing the information. Since server-providable software and information do not need to be stored in the computer that the user is operating, the user-operated computer specifications need not be high, making it possible to get by with a computer that has the minimum necessary specifications.

Thus, cloud computing is advantageous for the user, and in addition to data centers that provide cloud computing as a service, there are also cases where large corporations have constructed their own cloud computing environments for use inside their own companies.

Examples of cloud computing systems for realizing this kind of cloud computing are disclosed in Patent Document 1 and Patent Document 2 described below.

In addition to the aforementioned patent documents, in most conventional cloud computing systems, with the exception of original cloud computing that major enterprises promote for in-house use, the information used by the user is managed on servers at the data center of a third party company that provides the cloud computing service.

Thus, the information used by the user is not managed in the user's own computer environment, but rather in a third-party computer environment. in some cases, this information includes highly confidential information, such as in-house sales information, financial information, customer information, and new product information.

Accordingly, in cloud computing such as those disclosed in Non-Patent Document 1 and Non-Patent Document 2, a variety of security measures are taken, such as managing the information in the server in an encrypted manner.

Patent Document 1 refers to Japanese Laid-open Patent Application No. 2011-59884.

Patent Document 2 refers to Japanese Laid-open Patent Application No. 2011-76506.

Non-Patent Document 1 refers to Trend Micro Incorporated, “Trend Micro Secure Cloud Provides Optimum Encryption and Key Management Solutions for Cloud Environments”, [online], [retrieved 24 Aug. 2011], Internet <URL: http://jp.trendmicro.com/jp/products/enterprise/secureclound/>.

Non-Patent Document 2 refers to Oracle Corporation Japan, “'Security and Compliance Mechanism to be incorporation in Cloud”, [online], [retrieved 24 Aug. 2011], Internet <URL: http://oracledatabase.jp/dbsecurity/entry_{—}000101.html>.

### SUMMARY OF THE INVENTION

In one example of a cloud computing system, the cloud computing system includes (a) a mounting process unit that performs a process for mounting an external storage managed by an entity that is different from an entity that is providing a cloud computing service effected by said cloud computing system; (b) a user information storage unit for storing in an associated manner user identification information for a user who is using said mounted external storage and network identification information for said external storage; and (c) a cloud control process unit for using information stored in said external storage to execute, for a user terminal used by said user, a control process for said cloud computing system.

### BRIEF DESCRIPTION OF THE DRAWINGS

Further features and advantages of the invention will become apparent from reading the following detailed description in conjunction with the following drawings, in which like reference numbers refer to like parts:

FIG. 1 is a drawing showing the overall configuration of one example of a cloud computing system;

FIG. 2 is a conceptual drawing conceptually showing the functions of one example of the cloud computing system;

FIG. 3 is a drawing schematically showing an example of a hardware configuration;

FIG. 4 is a flowchart schematically showing an example of processing when mounting an external storage;

FIG. 5 is a flowchart schematically showing an example of processing when using the mounted external storage;

FIG. 6 is a drawing schematically showing an example of an authentication information storage unit; and

FIG. 7 is a drawing schematically showing an example of a user information storage unit.

### DETAILED DESCRIPTION

The examples and drawings provided in the detailed description are merely examples, and should not be used to limit the scope of the claims in any claim construction or interpretation.

### Problems to be Solved by the Invention

However, even though encryption and the like are being carried out does not change the fact that the environment is one in which lots of information is being managed, making the environment an easy target for attacks by “hackers.” Of course, as mentioned above, a variety of measures are being taken with respect thereto, but should security be broken, there is the likelihood of large amounts of important personal information and corporate secrets being leaked out.

Also, even when the information is not highly confidential to begin with, in many cases, users feel uncomfortable with the fact that information that they themselves originally managed is being managed by a third-party computer environment.

Thus, information management is undeniably an aspect that is obstructing the spread of cloud computing.

### Means Used to Solve the Above-Mentioned Problems

With the aforementioned technical problems in view, the present invention devises a cloud computing system that assures security by storing and managing information at an entity different from the entity that is operating the cloud computing service.

A first invention is a cloud computing system, that is, a cloud computing system comprising: a mounting process unit that performs a process for mounting an external storage managed by an entity different from an entity that provides a cloud computing service effected by the cloud computing system; a user information storage unit for storing in an associated manner user identification information for a user who uses the mounted external storage and network identification information for the external storage; and a cloud control process unit that executes, for a user terminal used by the user, a control process for the cloud computing system by using information stored in the external storage.

According to the aforedescribed aspect of the present invention, it is possible for the user to use an external storage other than a storage server managed by the entity operating the cloud computing service. Thus, the user can rely on the information management of the cloud computing system and assure confidentiality by specifying an external storage that he himself trusts. The present invention also does away with psychological anxiety, and as such makes it possible to promote the use of cloud computing by users.

The above-described invention can be configured as a cloud computing system in which the cloud control process unit extracts, in accordance with a processing request from the user terminal, the network identification information of the external storage corresponding to the user identification information stored in the user information storage unit, and by accessing the external storage on the basis of the extracted network identification information, extracts from the external storage information that is available to the user, and sends [the extracted information] to the user terminal.

The user is able to use the processes of the present invention to access a newly mounted external storage.

The above-described invention can be configured as a cloud computing system in which the cloud computing system further comprises a storage server managed by the entity that provides the cloud computing service effected by the cloud computing system, wherein the user information storage unit also stores information indicating a storage area in the storage server that is associated with the user identification information and is for use by the user, and the cloud control process unit, refers, in response a normal processing request from the user terminal, to the user information storage unit to access the storage area in the storage server that is used by the user, extracts information that is available to the user, and sends the extracted information to the user terminal, and refers, in response to a special processing request for accessing the external storage from the user terminal, to the user information storage unit to access the storage area in the external storage that is used by the user, extracts information that is available to the user, and sends [the extracted information] to the user terminal.

According to the aforedescribed aspect of the present invention, in addition to the external storage, the user can use in a parallel manner a storage server managed by the entity operating the cloud computing service. Therefore, a method of use corresponding to a confidentiality level, in which the user stores information for which confidentiality is not an issue in the storage server and stores confidential information in the external storage, is possible.

The above-described invention can be configured as a cloud computing system in which the cloud control process unit stores in the user information storage unit authentication information that is associated with the user identification information and is used for accessing the external storage, and when accessing the external storage, extracts the authentication information stored in the user information storage unit and uses the authentication information to access the external storage.

Unrestricted access to an external storage may not be possible; some sort of authentication process is most likely in place. In such cases, the authentication process can be dealt with by configuring the present invention in this manner.

### Effect of the Invention

Security can be assured by storing and managing information at an entity that is different from the cloud computing service operator. That is, a cloud computing service operator is apt to become the target of an attack by a hacker. However, by managing information at a different entity, the hacker has a hard time identifying where to attack, making it possible to assure the security of the information being managed. When this entity is the user's own storage device, the anxiety on the part of a user who feels uncomfortable having his information managed in a third-party computer environment is eliminated, making it possible for even users such as this to use cloud computing.

### BEST MODE FOR CARRYING OUT THE INVENTION

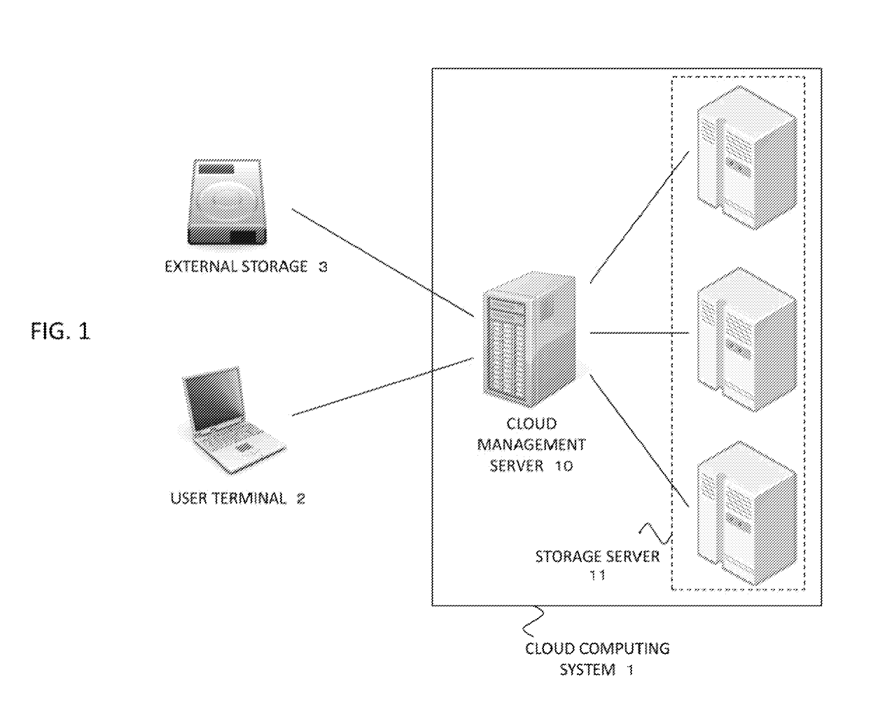

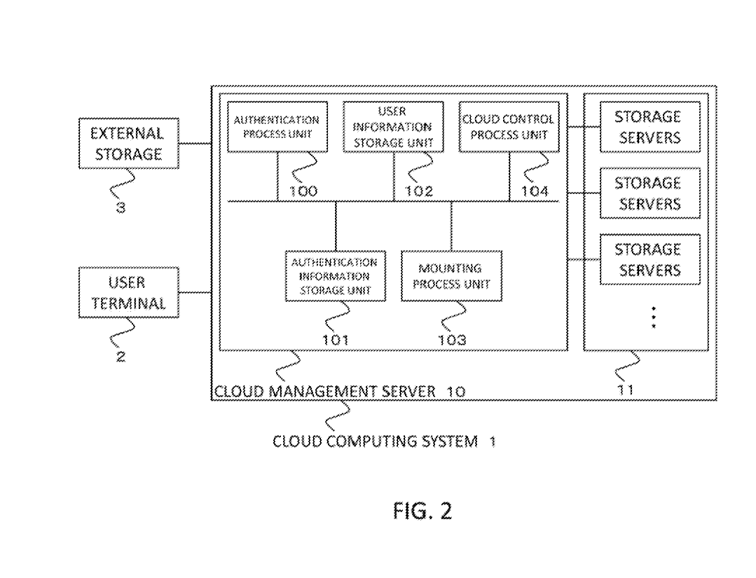

FIG. 1 schematically shows the overall configuration of the cloud computing system 1 of the present invention. A conceptual drawing conceptually showing the functions of the cloud computing system 1 of the present invention is schematically shown in FIG. 2.

The cloud computing system 1 has a cloud management server 10 and a storage server 11. The cloud computing system 1 is able to send and receive information to and from a user terminal 2 that is used by a user, and an external storage 3 that functions as the user's storage area.

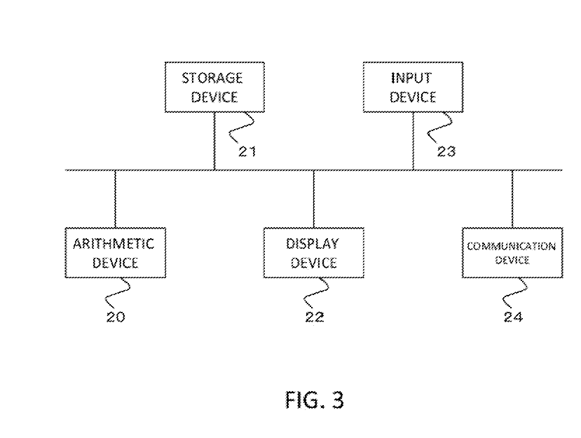

The cloud management server 10 in the cloud computing system 1 has a CPU or other such arithmetic device 20 for executing the arithmetic and logical processing of a program, a RAM, hard disk or other such storage device 21 for storing information, a keyboard, pointing device (mouse and/or ten-key pad or the like) or other such input device 23, and a communication device 24 for sending and receiving the processing results of the arithmetic device 20 and/or information stored in the storage device 21 over a network such as the Internet and/or a LAN. The processing of functions (means) realized via a computer is executed by processing-execution means (programs and/or modules or the like) being read into the arithmetic device 20. When information stored in the storage unit 21 is utilized in the processing of the functions, the relevant information is read from the storage unit 21, and the read information is used as needed in the processing in the arithmetic device 20. FIG. 3 schematically shows an example of the hardware configuration of the cloud management server 10. The functions of the cloud management server 10 may also be arranged in a distributed manner in a plurality of computer terminals or servers.

The storage server 11 is a data server for storing software programs provided to the user and information used by the user. In the storage device 21 of the storage server 11, an available storage area is allocated to each user, and each user can access only the storage area that has been allocated for his use.

The function of each means in the present invention is only distinguished logically, and these functions may be performed, either physically or actually, in the same area.

The user terminal 2 is the computer terminal of the user who is using the cloud computing system 1 of the present invention. When the user is a company, group or other such organization, the user terminal 2 includes the computer system used by the organization.

The external storage 3 is a user-dedicated storage area for use by the user, and is managed by an entity other than the service operator that operates the cloud computing system 1. It is desirable that the external storage 3 be a computer provided with a storage device 21. For example, a data server operated by a company other than the cloud computing system 1 service operator, or a network attached storage (NAS) managed by the user himself can be used. The NAS is a file server provided with a storage device 21 that is used by connecting to a network, and comprises an OS and/or storage device 21, a communication device 24, and other such functions required for functioning as a file server.

The cloud management server 10 has an authentication process unit 100, an authentication information storage unit 101, a user information storage unit 102, a mounting process unit 103, and a cloud control process unit 104.

When a user uses the cloud computing system 1, the authentication process unit 100 executes an authentication process for determining the legitimacy of the user on the basis of the authentication information storage unit 101, which will be described later on. That is, the authentication process unit 100 executes an authentication process by receiving an input of authentication information from the user terminal, comparing the received authentication information to authentication information stored in the authentication information storage unit 101, which will be described later on, and making a determination as to whether or not there is a match, In addition to receiving the input of a password and an ID for identifying the user, the authentication process may make a determination as to whether or not an IP address has been registered beforehand. In the case of a determination using the IP address, there is no need for an input by the user, and the cloud management server 10 may acquire the IP address when the user terminal 2 accesses the cloud management server 10, and may make a determination on the basis thereof.

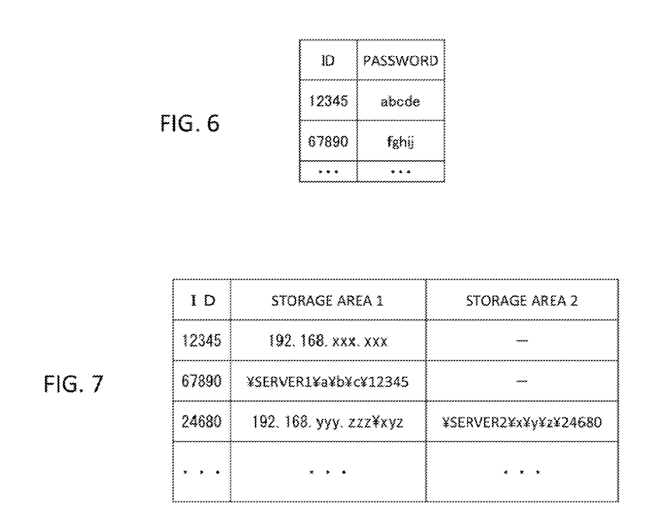

The authentication information storage unit 101 stores authentication information used in the authentication process of the authentication process unit 100. FIG. 6 schematically shows an example of the authentication information storage unit 101. When an ID and password are used as the authentication information, the [ID and password] are stored as shown in FIG. 6. When an IP address is used as the authentication information, the ID and the IP address are stored in an associated manner. In this case, the authentication process unit 100 may make a determination as to whether an IP address matching the received IP address exists.

The user information storage unit 102 stores information on the storage area to be accessed by the user in an associated manner with the user's ID (or the IP address of the user terminal used by the user). FIG. 7 schematically shows an example of the user information storage unit 102. The information on the storage area to be accessed by the user may specify a single storage area, or may specify a plurality of storage areas.

The mounting process unit 103 performs a process for mounting to the cloud computing system 1 an external storage 3 that is trusted by the user himself and is managed by an entity other than the service operator, as the storage area to be accessed by the user rather than the storage server 11 provided by the cloud computing service operator. The storage area of the external storage 3 mounted here is a storage area capable of being used in an exclusive manner by the user who performed the mounting. The entity that manages the external storage 3 may be anyone other than the service operator, and, for example, may be a storage server 11 managed by another data center operator, or the user's own NAS.

The mounting process unit 103 receives from the user terminal 2 the input of network identification information (for example, an IP address or the like) for the mounted external storage 3, and information (for example, a path) indicating the storage area to be used by the user within the external storage 3. Then, the mounting process unit 103, upon receiving the above-mentioned input, accesses the external storage 3 on the basis of the information indicating the IP address and the storage area, and checks whether the storage area of the external storage is available. Then, when it has been confirmed that the storage area is available, the mounting process unit 103 associates the storage area with the user ID, and stores the information indicating the IP address and the storage area of the mounted external storage 3 in the user information storage unit 102. In a case where the entire external storage 3 is available, only the IP address is required.

When a prescribed authentication process is required to access the external storage, the input of the authentication information is also received by the mounting process unit 103, and when accessing the external storage 3, the cloud management server 10 uses the authentication information to perform the access.

The cloud control process unit 104 executes all the processing related to cloud computing. That is, when a request for accessing cloud computing information is received from the user terminal 2, the cloud control process unit 104, based on the user ID, identifies an accessible storage area on the basis of the user information storage unit 102 and accesses the storage area. When a file storage request is received, the cloud control process unit 104, based on the user ID, identifies an accessible storage area on the basis of the user information storage unit 102, and stores the file in the storage area. In addition, when a request to execute a certain application software program is received, the cloud control process unit 104 accesses the storage server 11 storage area stored in the application software program, and controls the application software program to enable execution on the user terminal 2.

In this way, the cloud control process unit 104 executes a variety of control processes for cloud computing. The control processes are not limited to the processes described above, but rather involve a variety of control processes, and normally include control processes possible with cloud computing.

The storage server 11 is a storage area for storing information on each user that uses the cloud computing system 1, and comprises at least one or more units. The storage server 11 is accessed from the cloud management server 10, and provides required information to the user terminal 2 as needed. [The storage server 11] also receives and stores required information from the user terminal 2.

Preferably, information (for example, a path and so forth) indicating which storage area in which storage server 11 is the storage area to be used by the user is not visible from the user terminal 2, and the storage area can be used from the user terminal 2 the same as though the user were using the storage device 21 in his own computer terminal.

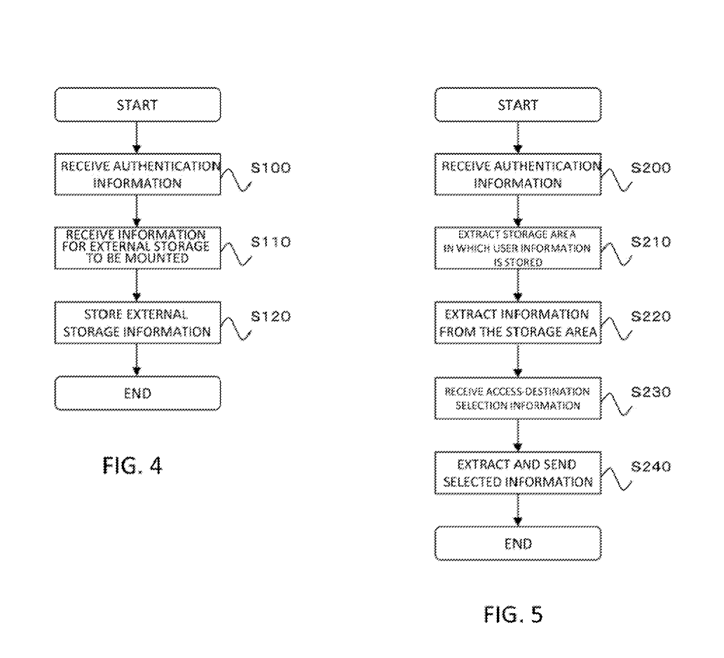

Next, examples of the processes of the cloud computing system 1 of the present invention will be explained using the flowcharts of FIGS. 4 and 5. It is assumed that authentication information has been registered beforehand for the user of the cloud computing system 1. It is also assumed that the user, for example, uses a NAS provided by the user himself as the external storage 3 rather than the storage server 11 provided in advance by the cloud computing system 1, but the processes are the same even for a storage server 11 other than a NAS.

When using the cloud computing system 1, the user first executes the process for mounting to the cloud management server 10 the NAS he himself will use.

The user accesses the cloud management server 10 and inputs the authentication information by performing prescribed operations on the user terminal 2 (S100). Then, when the authentication information inputted by the user terminal 2 is received by the authentication process unit 100, a comparison is made to the authentication information stored in the authentication information storage unit 101, and when there is no match, the user is prompted to re-input the authentication information.

Alternatively, when there is a match, the user is able to log in to the cloud computing system 1, and as such, performs a prescribed operation to display an input screen for mounting the external storage 3.

That is, in order to mount the external storage 3, the user inputs the IP address of the NAS to be used as the external storage 3, and information (a path and so forth) on a storage area in the NAS capable of being used in the cloud computing system 1. The information inputted here is received by the mounting process unit 103 (S110), and the mounting process unit 103 stores, in association with the user ID, the IP address of the external storage 3 to he mounted and information on a usable storage area in the user information storage unit 102 (S120).

In accordance therewith, “192.168.xxx.xxx” (where xxx are numerals capable of being used as an IP address) and information indicating an available storage area within the external storage 3 (nothing in particular is specified here since all of the storage areas are available) are stored in the user information storage [unit 102] as the storage area to be used by the user, for example, the user with the ID “12345”, and the process for mounting the external storage 3 is ended.

Next, when the user wants to use the information in the external storage 3, the user accesses the cloud management server 10 and inputs the authentication information by performing prescribed operations from the user terminal 2 (S200). Then, when the authentication information inputted by the user terminal 2 is received by the authentication process unit 100, a comparison is made to the authentication information stored in the authentication information storage unit 101, and when there is no match, the user is prompted to re-input the authentication information.

Alternatively, when there is a match, the user is able to log in to the cloud computing system 1, and as such, the cloud control process unit 104, on the basis of the user ID, refers to the user information storage unit 102 (when the IP address is used as the authentication information, [the cloud control process unit 104] may identify the ID associated with the IP address from the authentication information storage unit 101, and on the basis of the ID, may refer to the user information storage unit 102), and extracts information on the storage area to be used by the user (S210).

That is, the cloud control process unit 104 refers to the user information storage unit 102 on the basis of the ID “12345”, and extracts the associated IP address “192.168.xxx.xxx”.

Then, for the user terminal 2, the cloud control process unit 104 extracts, on the basis of the storage area information extracted in S210, index information, for example, a filename, a folder name, an application software name, and so forth, from among the information stored in the storage area of the external storage 3 specified as the storage area for cloud computing, and sends [the information] to the user terminal 2 (S220).

In the aforementioned example, the cloud control process unit 104 accesses the NAS having IP address “192.168.xxx.xxx”, extracts the filename, the folder name, the application software name, and other such information stored in the NAS, and sends the information to the user terminal 2.

The user terminal 2 selects the file and/or folder, and the application software to be accessed on the basis of the information stored in the storage area, such as the filename, folder name, and so forth stored in the external storage 3, which was sent from the cloud management server 10. Then, the selected items are sent from the user terminal 2 to the cloud control process unit 104, and received [by the cloud control process unit 104] (S230). The cloud control process unit 104, on the basis thereof, accesses the external storage 3, extracts the selected information, and sends the extracted information to the user terminal 2 via the cloud management server 10 (S240).

In accordance with the above processing, the user can even make an external storage 3 that he himself considers appropriate available in the cloud computing system 1.

Furthermore, in a case where processing is carried out between the user terminal 2 and the external storage 3, a load is placed on the cloud management server 10 when the process is executed via the cloud control process unit 104 of the cloud management server 10. Accordingly, a session may be established directly between the user terminal 2 and the external storage 3, and the sending and receiving of information may be carried out without going through the cloud management server 10.

In the above explanation, a case was given in which only one storage area (a storage area in the external storage 3) is used, but as in ID “24680” of FIG. 7, a plurality of storage areas may be used as appropriate. For example, ordinary information may be stored in the storage server 11 of the cloud computing system 1, and highly confidential information may be stored in an external storage 3 provided and mounted by the user himself.

In this case, the cloud control process unit 104, on the basis of the storage area information stored in the user information storage unit 102, can access the respective storage areas and send the information to the user terminal 2. The cloud control process unit 104, which normally accesses only the storage server 11, may access the external storage 3 for the first time by receiving a special operation input, for example, a password or the like, from the user terminal 2.

That is, in S210, the cloud control process unit 104, in a case where there is information from the user information storage unit 102 on a plurality of storage areas serving as the user storage area, identifies the storage area information of the storage server 11 managed by it itself (the service operator of the cloud computing system 1), accesses only this storage area, performs information extraction processing (S220), and sends the extracted information to the user terminal 2. Then, when a prescribed operation and/or password or other such special processing request (an access request for the external storage 3) is received from the user terminal 2, the cloud control process unit 104 extracts the storage area information of the external storage 3 on the basis of the storage area information stored in the user information storage unit 102, and sends the extracted information to the user terminal 2.

By performing this kind of processing, under normal circumstances, [the present invention] uses the storage server 11, and only accesses the external storage 3 when highly confidential information is being used, thereby making it possible to further enhance the confidentiality of the information.

### INDUSTRIAL APPLICABILITY

Using the cloud computing system 1 of the present invention makes it possible to ensure security since information is stored and managed by a different entity than the cloud computing service operator. That is, the cloud computing service operator is apt to be targeted for attack by a hacker. However, by managing the information at a different entity, the hacker cannot readily identify where to attack, making it possible to ensure the security of the information being managed. When this entity is the user's own storage device 21, the anxiety on the part of a user who feels uncomfortable having his information managed in a third-party computer environment is eliminated, enabling even users such as this to make use cloud computing.

### DESCRIPTION OF THE NUMERICAL SYMBOLS

The following is a list of reference numerals and associated parts as used in this specification and drawings:
1: Cloud Computing System
2: User Terminal
3: External Storage
10: Cloud Management Server
11: Storage Server
20: Arithmetic Device
21: Storage Device
22: Display Device
23: Input Device
24: Communication Device
100: Authentication Process Unit
101: Authentication Information Storage Unit
102: User Information Storage Unit
103: Mounting Process Unit
104: Cloud Control Process Unit

The scope of the claims should not be limited by the preferred embodiments and examples, but should be given the broadest interpretation consistent with the specification as a whole.

1. A cloud computing system, comprising:
(a) a mounting process unit that performs a process for mounting an external storage managed by an entity that is different from an entity that is providing a cloud computing service effected by said cloud computing system;
(b) a user information storage unit for storing in an associated manner user identification information for a user who is using said mounted external storage and network identification information for said external storage; and
(c) a cloud control process unit for using information stored in said external storage to execute, for a user terminal used by said user, a control process for said cloud computing system.

2. The cloud computing system according to claim 1, wherein the cloud control process unit
extracts, in response to a processing request from said user terminal, the network identification information for said external storage corresponding to said user identification information stored in said user information storage unit; and
accesses said external storage on the basis of said extracted network identification information, thereby extracting from said external storage, and sending to said user terminal, information available to said user.

3. The cloud computing system according to claim 1, further comprising:
a storage server managed by the entity that provides the cloud computing service effected by said cloud computing system;
said user information storage unit additionally storing information that is associated with said user identification information, and that indicates a storage area to be used by said user in said storage server; and
said cloud control process unit refers, in response to a normal processing request from said user terminal, to said user information storage unit to access the storage area used by said user in said storage server, extracts information available to said user, and sends said available information to said user terminal; and
refers, in response to a special processing request for accessing said external storage from said user terminal, to said user information storage unit to access the storage area used by said user in said external storage, extracts information available to said user, and sends said available information to said user terminal.

4. The cloud computing system according to claim 1 wherein said cloud control process unit
stores in said user information storage unit authentication information that is associated with said user identification information and is used for accessing said external storage; and
when accessing said external storage, extracts said authentication information stored in said user information storage unit, and uses the authentication information to access said external storage.
